(19) United States
(12) Patent Application Publication
(10) Pub. No.: US 2025/0099814 A1
(43) Pub. Date: Mar. 27, 2025

(54) DETECTING AND TRACKING A WORKOUT USING SENSORS

(71) Applicant: Apple Inc., Cupertino, CA (US)

(72) Inventors: Thomas G. SALTER, San Francisco, CA (US); Christopher I. WORD, San Francisco, CA (US); Jeffrey S. NORRIS, Saratoga, CA (US); Ioana NEGOITA, Mountain View, CA (US); Trent A. GREENE, Santa Clara, CA (US); Finnegan N. SINCLAIR, Seattle, WA (US); Brian W. TEMPLE, Santa Clara, CA (US); Ian PERRY, San Jose, CA (US); Michael J. ROCKWELL, Palo Alto, CA (US)

(21) Appl. No.: 18/893,643

(22) Filed: Sep. 23, 2024

Related U.S. Application Data
(60) Provisional application No. 63/682,652, filed on Aug. 13, 2024.
(60) Provisional application No. 63/611,681, filed on Dec. 18, 2023.
(60) Provisional application No. 63/585,187, filed on Sep. 25, 2023.

(51) Int. Cl. A63B 24/00; A63B 71/06

(52) U.S. Cl. CPC A63B 24/0062; A63B 71/06; A63B 2024/0065

(57) ABSTRACT

Some examples of the disclosure are directed to systems and methods for presenting extended reality environments and, more particularly, to displaying one or more images relating to exercises in a physical environment while presenting an extended reality environment. In some situations, the electronic device detects an initiation of an exercise activity of a user of the electronic device using at least an optical sensor. In some examples, the electronic device presents a user interface including a representation of the identified exercise activity in the extended reality environment. In some examples, in response to detecting progression of the identified exercise activity, the user interface is updated with the updated representation of the exercise activity. In some examples, the electronic device presents a rest user interface during rest periods and/or after detecting rest.

### CROSS-REFERENCE TO RELATED APPLICATIONS

This application claims the benefit of U.S. Provisional Application No. 63/682,652, filed Aug. 13, 2024, U.S. Provisional Application No. 63/611,681, filed Dec. 18, 2023, and U.S. Provisional Application No. 63/585,187, filed Sep. 25, 2023, the contents of which are herein incorporated by reference in their entireties for all purposes.

### FIELD OF THE DISCLOSURE

This relates generally to systems and methods for detecting and processing a workout using sensors, and more particularly to tracking and recording various exercises in a workout on an extended reality device.

### BACKGROUND OF THE DISCLOSURE

Some computer graphical environments provide two-dimensional and/or three-dimensional environments where at least some objects presented for a user's viewing are virtual and generated by a computer. In some examples, computer graphical environments can be based on one or more images of the physical environment of the computer.

### SUMMARY OF THE DISCLOSURE

This relates generally to systems and methods of presenting extended reality environments and, more particularly, to displaying one or more images relating to exercises in a physical environment while presenting an extended reality environment. In some examples, presenting the extended reality environment with an electronic device includes presenting pass-through video of the physical environment of the electronic device. As described herein, for example, presenting pass-through video can include displaying virtual or video passthrough in which the electronic device uses a display to display images of the physical environment. In other examples, presenting the extended reality environment with an electronic device includes presenting true or real optical see-through in which portions of the physical environment are visible to the user through a transparent portion of the display. In some situations, the electronic device detects an initiation of an exercise activity of a user of the electronic device using at least an optical sensor. In some examples, the electronic device presents a user interface including a representation of the repetition of the identified exercise activity in the extended reality environment, such as on the pass-through video or optical see-through. In some examples, in response to detecting a completion of a repetition of the identified exercise activity, the user interface is updated with the updated representation of repetitions of the exercise activity. In some examples, the electronic device presents a rest user interface during rest periods and/or after detecting rest.

The full descriptions of these examples are provided in the Drawings and the Detailed Description, and it is understood that this Summary does not limit the scope of the disclosure in any way.

### BRIEF DESCRIPTION OF THE DRAWINGS

FIG. 1 illustrates an electronic device presenting an extended reality environment according to some examples of the disclosure.

FIG. 2 illustrates a block diagram of an example architecture for a device according to some examples of the disclosure.

FIGS. 3A-3R illustrate examples of how an electronic device records and tracks exercise activities.

FIG. 4 illustrates an example process of how an electronic device records and tracks exercise activities.

### DETAILED DESCRIPTION

This relates generally to systems and methods of presenting extended reality environments and, more particularly, to displaying one or more images relating to exercises in a physical environment while presenting an extended reality environment. In some examples, presenting the extended reality environment with an electronic device includes presenting pass-through video of the physical environment of the electronic device. As described herein, for example, presenting pass-through video can include displaying virtual or video passthrough in which the electronic device uses a display to display images of the physical environment. In other examples, presenting the extended reality environment with an electronic device includes presenting true or real optical see-through in which portions of the physical environment are visible to the user through a transparent portion of the display. In some situations, the electronic device detects an initiation of an exercise activity of a user of the electronic device using at least an optical sensor. In some examples, the electronic device presents a user interface including a representation of the repetition of the identified exercise activity in the extended reality environment, such as on the pass-through video or optical see-through. In some examples, in response to detecting a completion of a repetition of the identified exercise activity, the user interface is updated with the updated representation of repetitions of the exercise activity.

In some examples, a three-dimensional object is displayed in a computer-generated three-dimensional environment with a particular orientation that controls one or more behaviors of the three-dimensional object (e.g., when the three-dimensional object is moved within the three-dimensional environment). In some examples, the orientation in which the three-dimensional object is displayed in the three-dimensional environment is selected by a user of the electronic device or automatically selected by the electronic device. For example, when initiating presentation of the three-dimensional object in the three-dimensional environment, the user may select a particular orientation for the three-dimensional object or the electronic device may automatically select the orientation for the three-dimensional object (e.g., based on a type of the three-dimensional object).

In some examples, a three-dimensional object can be displayed in the three-dimensional environment in a world-locked orientation, a body-locked orientation, a tilt-locked orientation, or a head-locked orientation, as described below. As used herein, an object that is displayed in a body-locked orientation in a three-dimensional environment has a distance and orientation offset relative to a portion of the user's body (e.g., the user's torso). Alternatively, in some examples, a body-locked object has a fixed distance from the user without the orientation of the content being referenced to any portion of the user's body (e.g., may be displayed in the same cardinal direction relative to the user, regardless of head and/or body movement). Additionally or alternatively, in some examples, the body-locked object may be configured to always remain gravity or horizon (e.g., normal to gravity) aligned, such that head and/or body changes in the roll direction would not cause the body-locked object to move within the three-dimensional environment. Rather, translational movement in either configuration would cause the body-locked object to be repositioned within the three-dimensional environment to maintain the distance offset.

As used herein, an object that is displayed in a head-locked orientation in a three-dimensional environment has a distance and orientation offset relative to the user's head. In some examples, a head-locked object moves within the three-dimensional environment as the user's head moves (as the viewpoint of the user changes).

As used herein, an object that is displayed in a world-locked orientation in a three-dimensional environment does not have a distance or orientation offset relative to the user.

As used herein, an object that is displayed in a tilt-locked orientation in a three-dimensional environment (referred to herein as a tilt-locked object) has a distance offset relative to the user, such as a portion of the user's body (e.g., the user's torso) or the user's head. In some examples, a tilt-locked object is displayed at a fixed orientation relative to the three-dimensional environment. In some examples, a tilt-locked object moves according to a polar (e.g., spherical) coordinate system centered at a pole through the user (e.g., the user's head). For example, the tilt-locked object is moved in the three-dimensional environment based on movement of the user's head within a spherical space surrounding (e.g., centered at) the user's head. Accordingly, if the user tilts their head (e.g., upward or downward in the pitch direction) relative to gravity, the tilt-locked object would follow the head tilt and move radially along a sphere, such that the tilt-locked object is repositioned within the three-dimensional environment to be the same distance offset relative to the user as before the head tilt while optionally maintaining the same orientation relative to the three-dimensional environment. In some examples, if the user moves their head in the roll direction (e.g., clockwise or counterclockwise) relative to gravity, the tilt-locked object is not repositioned within the three-dimensional environment.

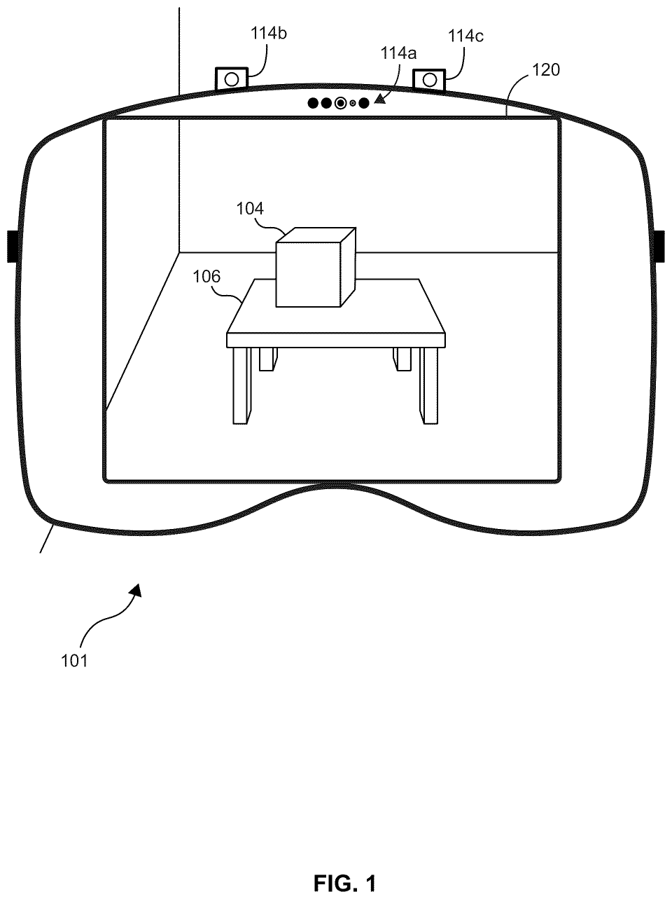

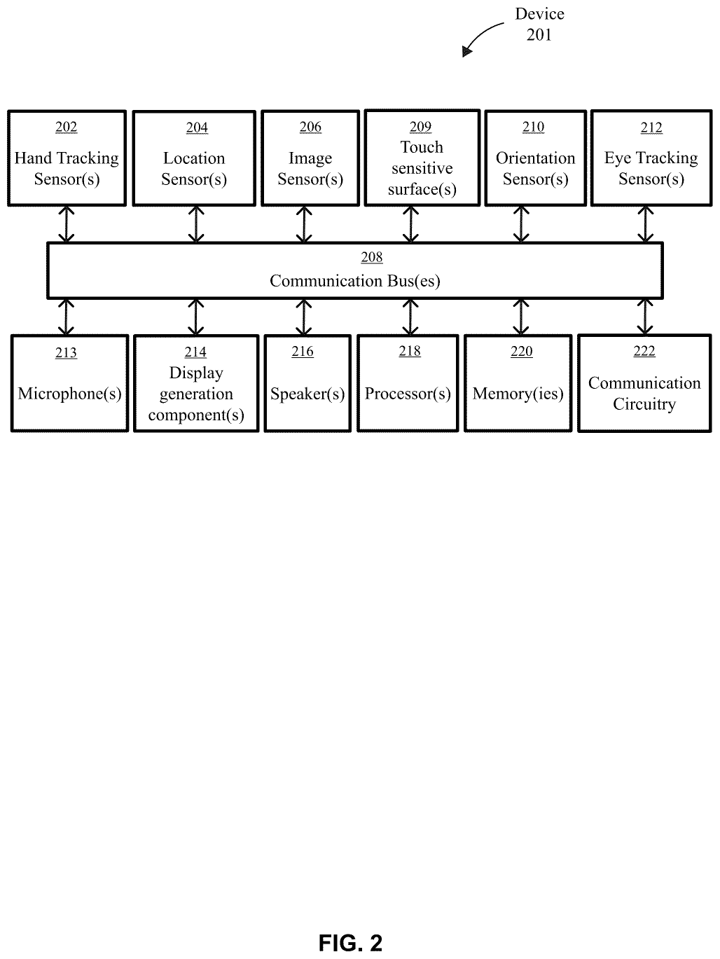

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIG. 2). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device may be a video-passthrough device in which display 120 is an opaque display configured to display images of the physical environment captured by external image sensors 114b and 114c.

In some examples, in response to a trigger, the electronic device 101 may be configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120 of the electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an example architecture for an electronic device 201 according to some examples of the disclosure. In some examples, electronic device 201 includes one or more electronic devices. For example, the electronic device 201 may be a portable device, an auxiliary device in communication with another device, a head-mounted display, etc., respectively. In some examples, electronic device 201 corresponds to electronic device 101 described above with reference to FIG. 1.

As illustrated in FIG. 2, the electronic device 201 optionally includes various sensors, such as one or more hand tracking sensors 202, one or more location sensors 204, one or more image sensors 206 (optionally corresponding to internal image sensors 114a and/or external image sensors 114b and 114c in FIG. 1), one or more touch-sensitive surfaces 209, one or more motion and/or orientation sensors 210, one or more eye tracking sensors 212, one or more microphones 213 or other audio sensors, one or more body tracking sensors (e.g., torso and/or head tracking sensors), one or more display generation components 214, optionally corresponding to display 120 in FIG. 1, one or more speakers 216, one or more processors 218, one or more memories 220, and/or communication circuitry 222. One or more communication buses 208 are optionally used for communication between the above-mentioned components of electronic devices 201.

Communication circuitry 222 optionally includes circuitry for communicating with electronic devices, networks, such as the Internet, intranets, a wired network and/or a wireless network, cellular networks, and wireless local area networks (LANs). Communication circuitry 222 optionally includes circuitry for communicating using near-field communication (NFC) and/or short-range communication, such as Bluetooth®.

Processor(s) 218 include one or more general processors, one or more graphics processors, and/or one or more digital signal processors. In some examples, memory 220 is a non-transitory computer-readable storage medium (e.g., flash memory, random access memory, or other volatile or non-volatile memory or storage) that stores computer-readable instructions configured to be executed by processor(s) 218 to perform the techniques, processes, and/or methods described below. In some examples, memory 220 can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214 include a single display (e.g., a liquid-crystal display (LCD), organic light-emitting diode (OLED), or other types of display). In some examples, display generation component(s) 214 includes multiple displays. In some examples, display generation component(s) 214 can include a display with touch capability (e.g., a touch screen), a projector, a holographic projector, a retinal projector, a transparent or translucent display, etc. In some examples, electronic device 201 includes touch-sensitive surface(s) 209, respectively, for receiving user inputs, such as tap inputs and swipe inputs or other gestures. In some examples, display generation component(s) 214 and touch-sensitive surface(s) 209 form touch-sensitive display(s) (e.g., a touch screen integrated with electronic device 201 or external to electronic device 201 that is in communication with electronic device 201).

Electronic device 201 optionally includes image sensor(s) 206. Image sensors(s) 206 optionally include one or more visible light image sensors, such as charged coupled device (CCD) sensors, and/or complementary metal-oxide-semiconductor (CMOS) sensors operable to obtain images of physical objects from the real-world environment. Image sensor(s) 206 also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206 also optionally include one or more cameras configured to capture movement of physical objects in the real-world environment. Image sensor(s) 206 also optionally include one or more depth sensors configured to detect the distance of physical objects from electronic device 201. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic device 201 uses CCD sensors, event cameras, and depth sensors in combination to detect the physical environment around electronic device 201. In some examples, image sensor(s) 206 include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 201 uses image sensor(s) 206 to detect the position and orientation of electronic device 201 and/or display generation component(s) 214 in the real-world environment. For example, electronic device 201 uses image sensor(s) 206 to track the position and orientation of display generation component(s) 214 relative to one or more fixed objects in the real-world environment.

In some examples, electronic device 201 includes microphone(s) 213 or other audio sensors. Electronic device 201 optionally uses microphone(s) 213 to detect sound from the user and/or the real-world environment of the user. In some examples, microphone(s) 213 includes an array of microphones (a plurality of microphones) that optionally operate in tandem, such as to identify ambient noise or to locate the source of sound in space of the real-world environment.

Electronic device 201 includes location sensor(s) 204 for detecting a location of electronic device 201 and/or display generation component(s) 214. For example, location sensor(s) 204 can include a global positioning system (GPS) receiver that receives data from one or more satellites and allows electronic device 201 to determine the device's absolute position in the physical world.

Electronic device 201 includes orientation sensor(s) 210 for detecting orientation and/or movement of electronic device 201 and/or display generation component(s) 214. For example, electronic device 201 uses orientation sensor(s) 210 to track changes in the position and/or orientation of electronic device 201 and/or display generation component(s) 214, such as with respect to physical objects in the real-world environment. Orientation sensor(s) 210 optionally include one or more gyroscopes and/or one or more accelerometers.

Electronic device 201 includes hand tracking sensor(s) 202 and/or eye tracking sensor(s) 212 (and/or other body tracking sensor(s), such as leg, torso and/or head tracking sensor(s)), in some examples. Hand tracking sensor(s) 202 are configured to track the position/location of one or more portions of the user's hands, and/or motions of one or more portions of the user's hands with respect to the extended reality environment, relative to the display generation component(s) 214, and/or relative to another defined coordinate system. Eye tracking sensor(s) 212 are configured to track the position and movement of a user's gaze (eyes, face, or head, more generally) with respect to the real-world or extended reality environment and/or relative to the display generation component(s) 214. In some examples, hand tracking sensor(s) 202 and/or eye tracking sensor(s) 212 are implemented together with the display generation component(s) 214. In some examples, the hand tracking sensor(s) 202 and/or eye tracking sensor(s) 212 are implemented separate from the display generation component(s) 214.

In some examples, the hand tracking sensor(s) 202 (and/or other body tracking sensor(s), such as leg, torso and/or head tracking sensor(s)) can use image sensor(s) 206 (e.g., one or more IR cameras, 3D cameras, depth cameras, etc.) that capture three-dimensional information from the real-world including one or more hands (e.g., of a human user). In some examples, the hands can be resolved with sufficient resolution to distinguish fingers and their respective positions. In some examples, one or more image sensors 206 are positioned relative to the user to define a field of view of the image sensor(s) 206 and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic device 201 is not limited to the components and configuration of FIG. 2, but can include fewer, other, or additional components in multiple configurations. In some examples, electronic device 201 can be implemented between two electronic devices (e.g., as a system). In some such examples, each of (or more) electronic device may each include one or more of the same components discussed above, such as various sensors, one or more display generation components, one or more speakers, one or more processors, one or more memories, and/or communication circuitry. A person or persons using electronic device 201, is optionally referred to herein as a user or users of the device.

Attention is now directed towards interactions with one or more virtual objects that are displayed in a three-dimensional environment presented at an electronic device (e.g., corresponding to electronic device 201 and/or electronic device 101). In some examples, the electronic device adjusts the motion of the one or more virtual objects in accordance with a detected movement pattern of the electronic device. As discussed below, the electronic device may detect, using one or more input devices (e.g., image sensor(s) 206, orientation sensor(s) 210, inertial measurement unit (IMU) sensors, and other sensors), an initiation of an exercise activity in a workout. In some examples, and as described below, the electronic device may record repetitions and sets of repetitions of the exercise activity as the user is performing the exercise activity. In some examples, the electronic device may display the representation of the repetitions and sets of repetitions in the three-dimensional environment, such as with a virtual object. Recording workouts and exercise activities is time-consuming. Some existing workout trackers require that a user manually enter types, repetitions, and sets of an exercise activity. These existing workout trackers do not automatically recognize a workout or exercise activity and do not record the workout without additional input from a user.

To solve the technical problem outlined above, exemplary methods and/or systems are provided where exercise activities that are performed by a user in a physical environment are identified and recorded. When exercise activities are initiated, a visual indication of the exercise activity and attributes of the exercise activity, such as the number of repetitions and sets of the exercise activity are displayed in the three-dimensional environment so that the user does not need to mentally keep track of the details of each exercise activity.

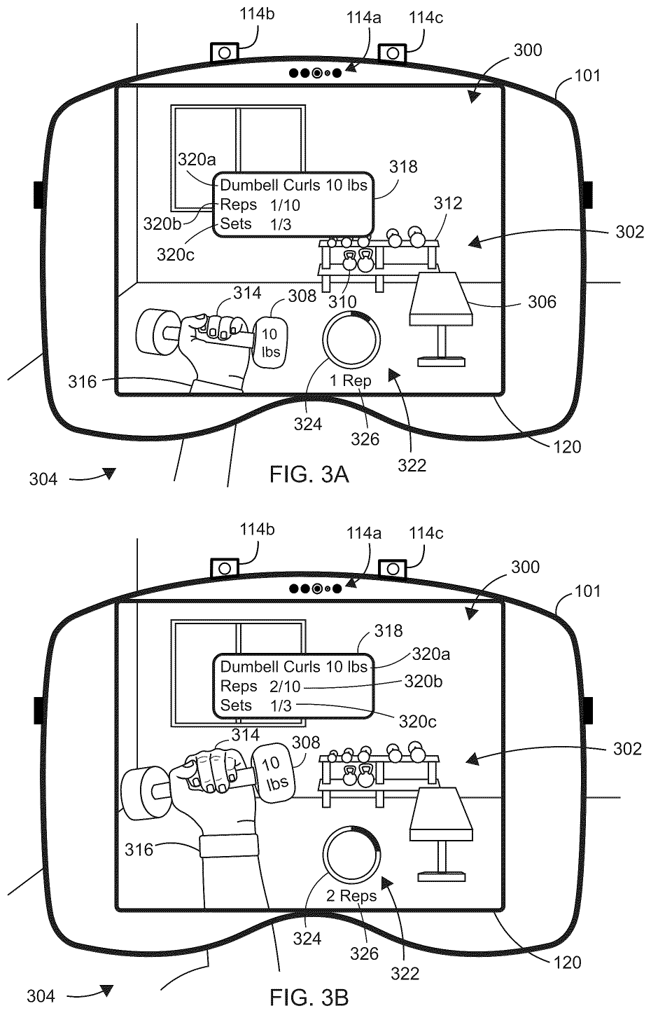

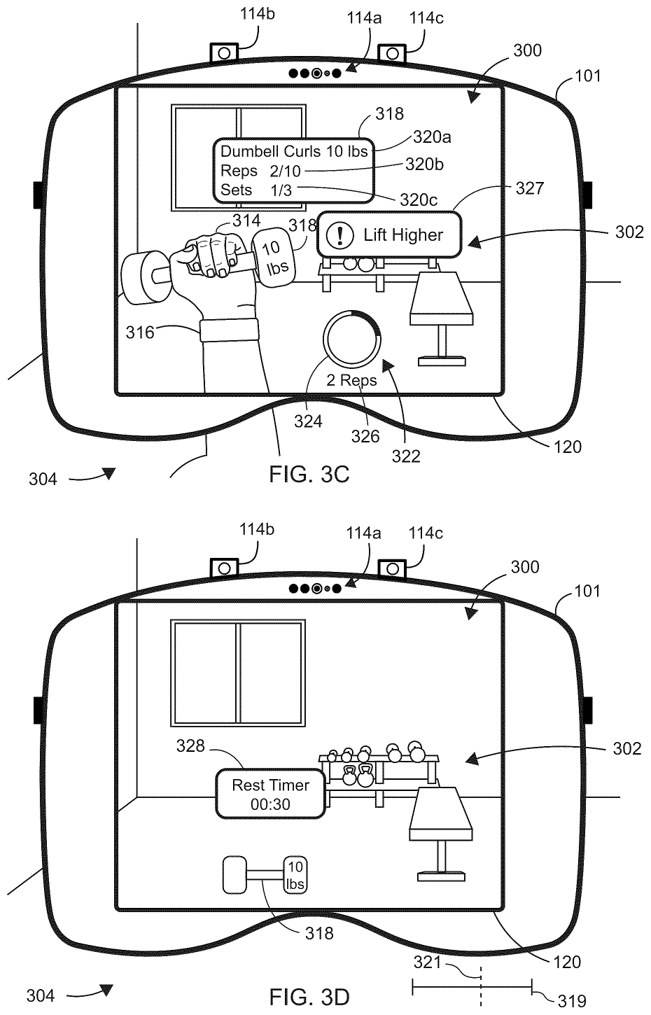

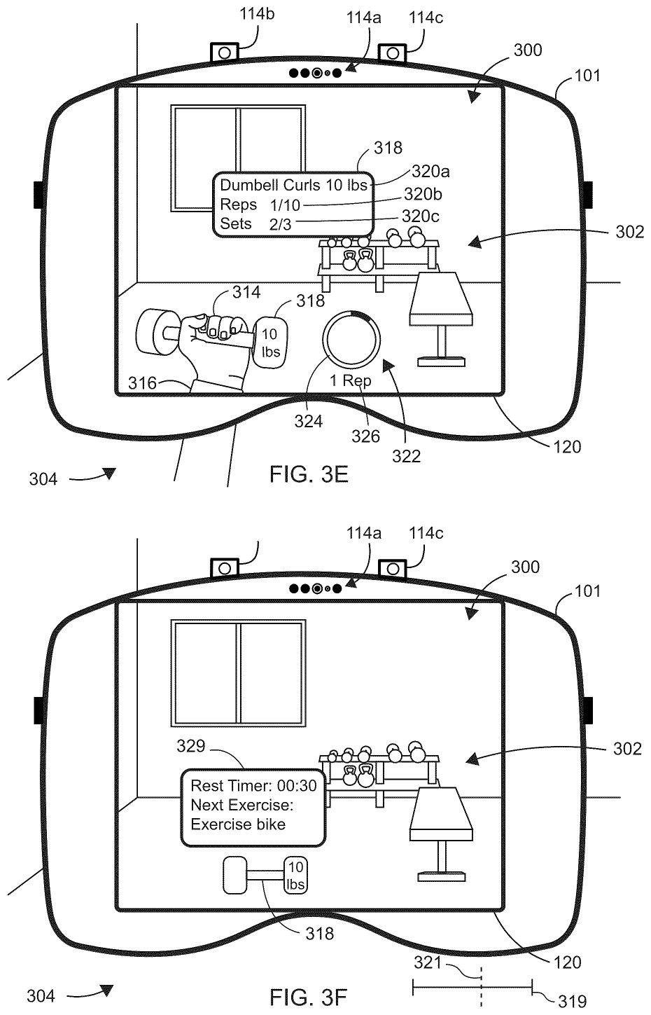

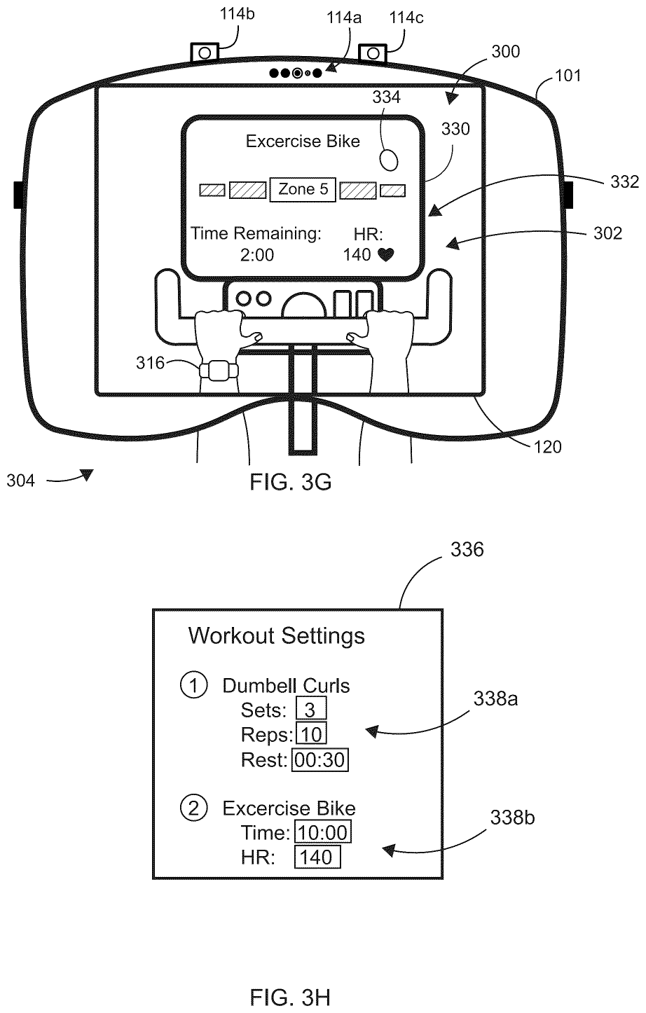

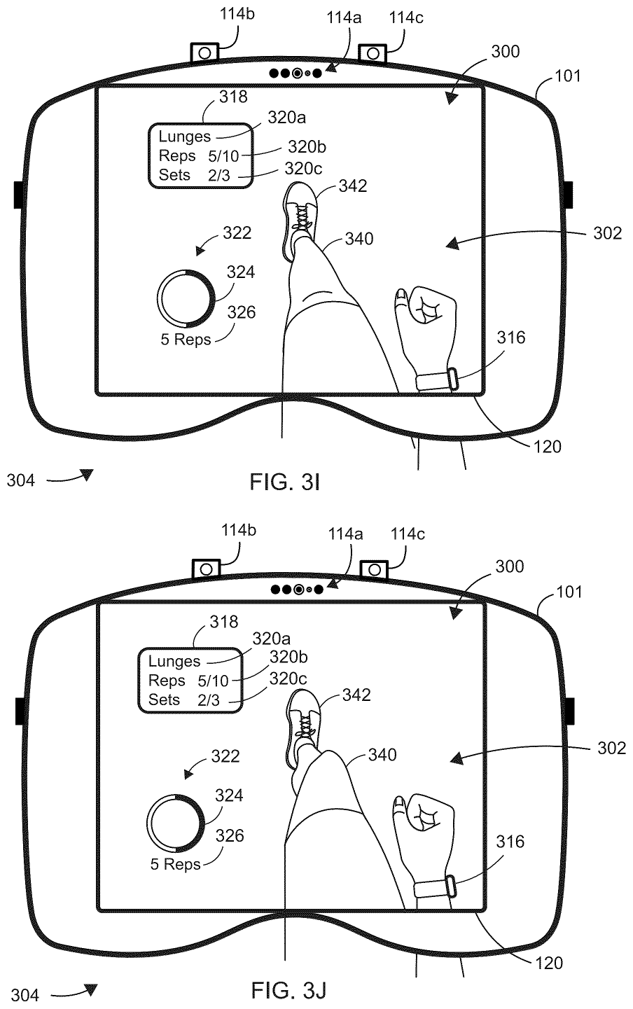

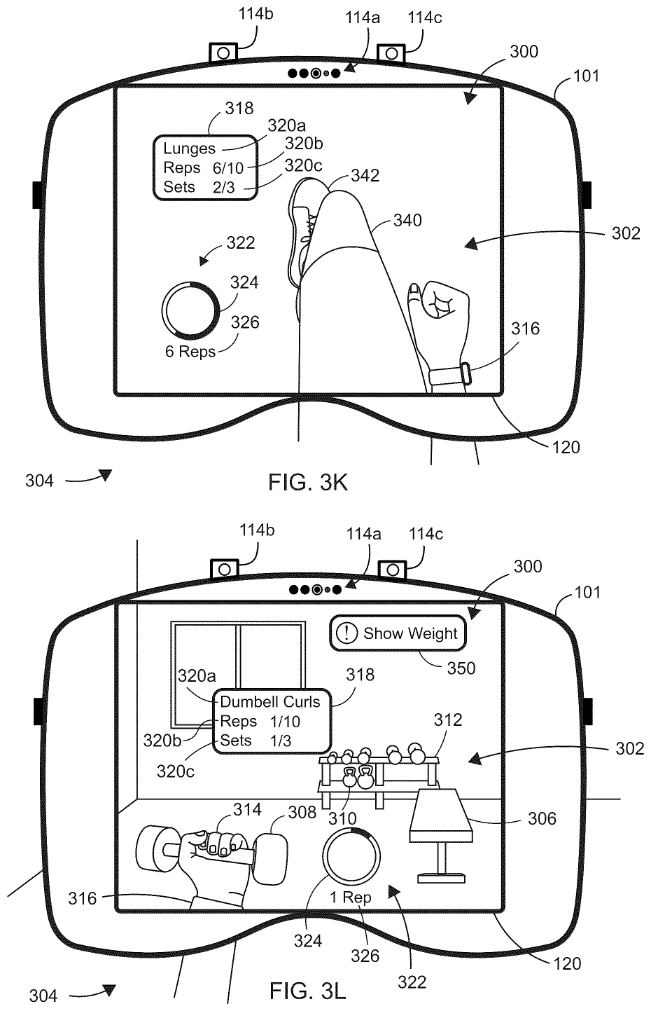

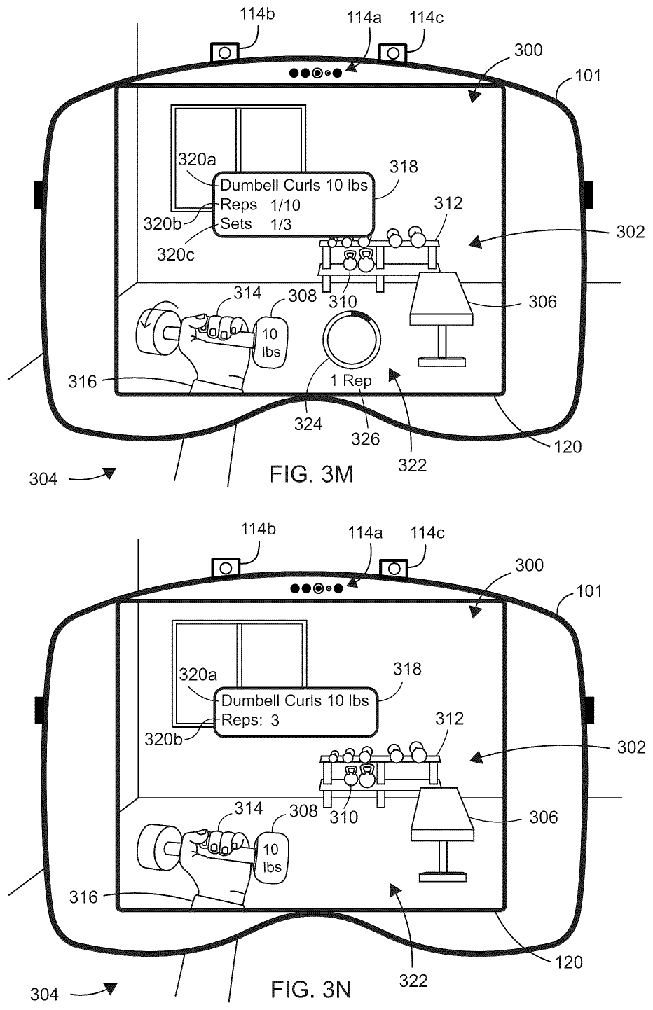

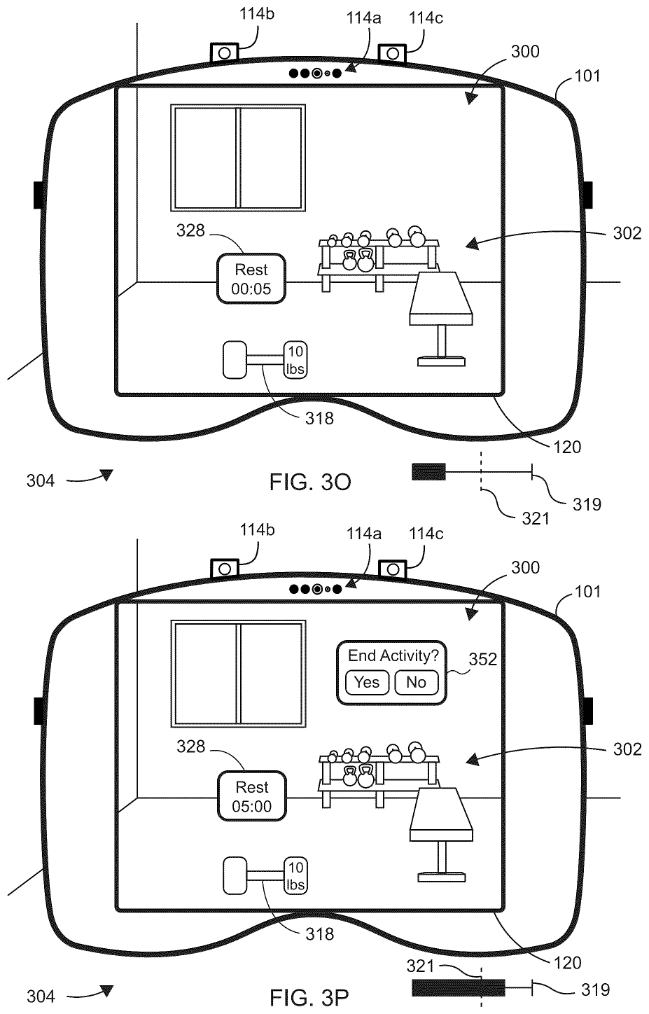

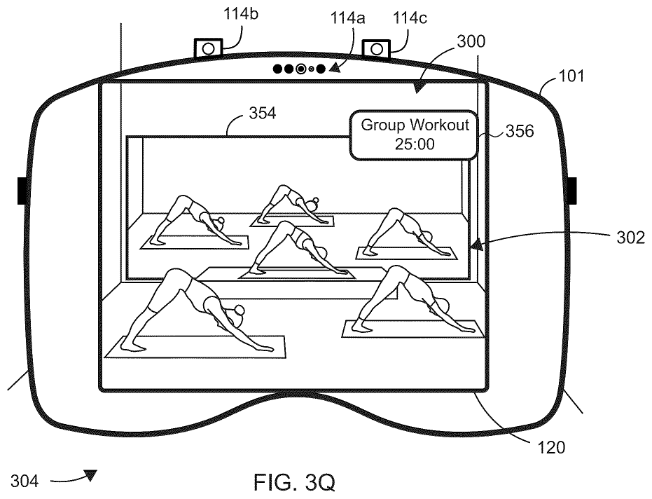

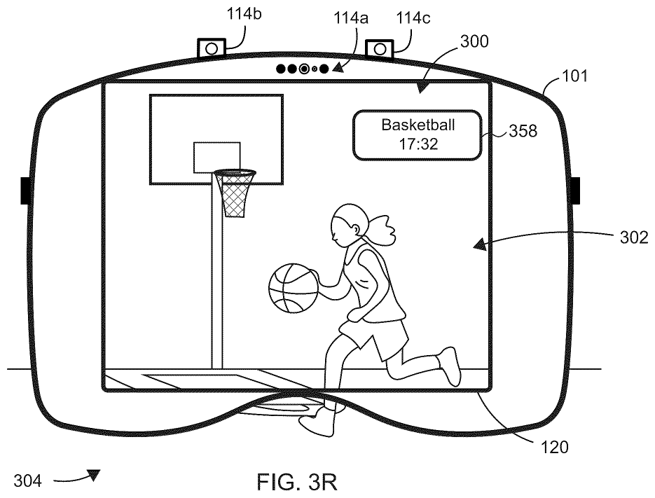

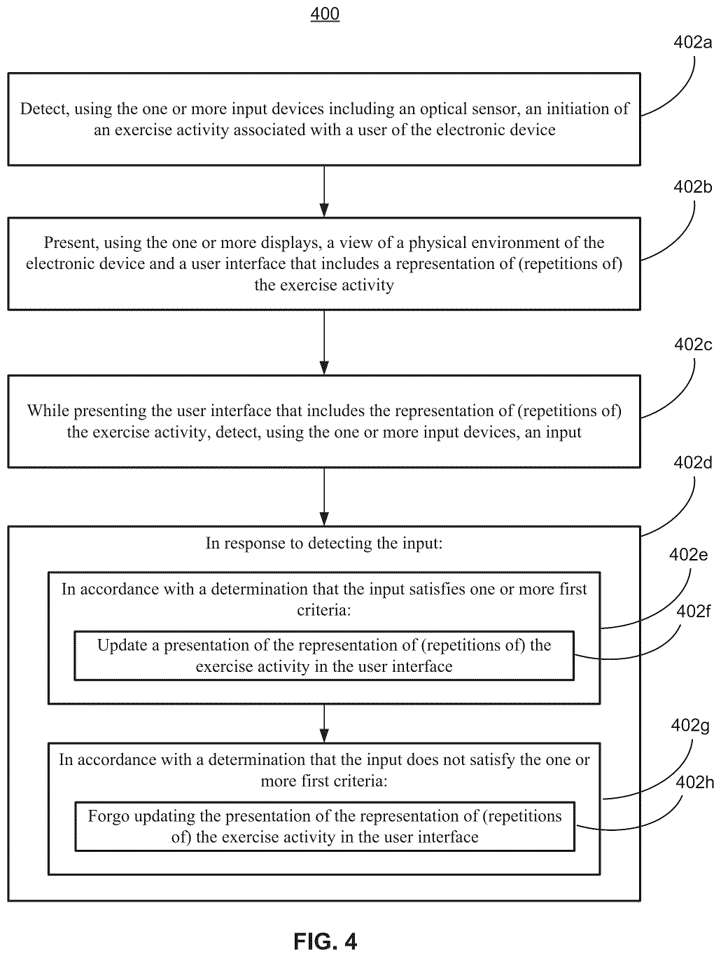

FIGS. 3A-3R illustrate examples of how an electronic device records and tracks exercise activities. FIGS. 3A-3R are used to illustrate the processes described below, including process 400 in FIG. 4.

FIG. 3A illustrates an electronic device 101 presenting, via the display 120, a three-dimensional environment 300 from a point of view of the user of the electronic device 101 (e.g., facing a free-weight area 302 in a gym in which electronic device 101 is located). In some examples, a viewpoint of a user determines what content (e.g., physical and/or virtual objects) is visible in a viewport (e.g., a view of the three-dimensional environment 300 visible to the user via one or more display(s) 120, a display or a pair of display modules that provide stereoscopic content to different eyes of the same user). In some examples, the (virtual) viewport has a viewport boundary that defines an extent of the three-dimensional environment 300 that is visible to the user via the display 120 in FIGS. 3A-3J. In some examples, the region defined by the viewport boundary is smaller than a range of vision of the user in one or more dimensions (e.g., based on the range of vision of the user, size, optical properties or other physical characteristics of the one or more displays, and/or the location and/or orientation of the one or more displays relative to the eyes of the user). In some examples, the region defined by the viewport boundary is larger than a range of vision of the user in one or more dimensions (e.g., based on the range of vision of the user, size, optical properties or other physical characteristics of the one or more displays, and/or the location and/or orientation of the one or more displays relative to the eyes of the user). The viewport and viewport boundary typically move as the one or more displays move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location, a direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include displays with video passthrough, portions of the physical environment that are visible (e.g., displayed, and/or projected) via the one or more displays are based on a field of view of one or more cameras in communication with the displays which typically move with the displays (e.g., moving with a head of the user for a head-mounted device or moving with a hand of a user for a handheld device such as a tablet or smartphone) because the viewpoint of the user moves as the field of view of the one or more cameras moves (and the appearance of one or more virtual objects displayed via the one or more displays is updated based on the viewpoint of the user (e.g., displayed positions and poses of the virtual objects are updated based on the movement of the viewpoint of the user)). For displays with optical see-through, portions of the physical environment that are visible (e.g., optically visible through one or more partially or fully transparent portions of the display generation component) via the one or more displays are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the displays moves (and the appearance of one or more virtual objects is updated based on the viewpoint of the user).

In FIG. 3A, the electronic device 101 includes a display 120 and a plurality of sensors as described above and controlled by the electronic device 101 to capture one or more images of a user or part of a user (e.g., one or more hands of the user) while the user interacts with the electronic device 101. In some examples, virtual objects, virtual content, and/or user interfaces illustrated and described below could also be implemented on a head-mounted display that includes a display or display generation component that displays the virtual objects, virtual content, user interfaces or three-dimensional environment to the user, and sensors to detect the physical environment and/or movements of the user's hands (e.g., external sensors facing outwards from the user), and/or attention (e.g., including gaze) of the user (e.g., internal sensors facing inwards towards the face of the user). The figures herein illustrate a three-dimensional environment that is presented to the user by electronic device 101 (e.g., and displayed by the display 120 of electronic device 101). In some examples, electronic device 101 may be similar to device 101 in FIG. 1, or device 201 in FIG. 2, and/or may be a head mountable system/device and/or projection-based system/device (including a hologram-based system/device) configured to generate and present a three-dimensional environment, such as, for example, heads-up displays (HUDs), head mounted displays (HMDs), windows having integrated display capability, displays formed as lenses designed to be placed on a person's eyes (e.g., similar to contact lenses), respectively.

As shown in FIG. 3A, the electronic device 101 captures (e.g., using external image sensors 114b and 114c) one or more images of a physical environment 304 around electronic device 101, including one or more objects (e.g., bench 306, dumbbell 308, kettlebell 310, and rack 312) in the physical environment 304 around the electronic device 101. In some examples, the electronic device 101 displays representations of the physical environment 304 in the three-dimensional environment or portions of the physical environment 304 are visible via the display 120 of electronic device 101. For example, the three-dimensional environment 300 includes bench 306, dumbbell 308, kettlebell 310, and rack 312 in the physical environment 304.

In some examples, the electronic device 101 detects an initiation of an exercise activity (e.g., dumbbell curls, planks, biking, squatting, or other exercises) in accordance with environmental cues. For example, the electronic device detects a location of the electronic device 101 using one or more sensors (e.g., a GPS). In some examples, the location of the electronic device 101 is a location where exercise activities typically occur, such as a gym, in a house, or in a user-defined location that is related to exercise (e.g., a friend's garage gym, a park, or other locations). Additionally, the electronic device 101 may use object recognition to identify the one or more objects in the physical environment 304 around electronic device 101 as objects related to exercising. For example, objects such as weights, exercise equipment (e.g., squat racks, treadmills, ellipticals, and/or bicycles) are optionally environmental cues that an exercise activity will occur. Additionally, in some examples, the electronic device 101 uses motion sensors such as an IMU sensor to identify movement. In some examples, the electronic device 101 may receive sensor data from other devices that the user is using. For example, the electronic device 101 may receive IMU data from a smart watch on the user or from a phone on the user. Additionally, in some examples, the electronic device 101 detects an initiation of an exercise activity using skeletal tracking of the user.

In FIG. 3A, the electronic device 101 uses one of the aforementioned methods to identify that the user is performing an exercise activity and the type of exercise activity (e.g., dumbbell curls). For example, the electronic device 101 may use object recognition to identify a physical object (e.g., the dumbbell 308 in the user's hand 314). Additionally, the electronic device 101 may use object recognition or optical character recognition (OCR) to identify the weight of the dumbbell 308. For example, in FIG. 3A, the dumbbell 308 has an indicator (e.g., a label or other marker) indicating that the dumbbell weighs 10 pounds (lbs.). In response to identifying this indicator, the electronic device 101 recognizes that the dumbbell weighs 10 lbs. Alternatively, in some examples, the electronic device 101 may use object recognition to recognize standard sizes, colors, and/or other visual characteristics to determine particular weights for machines and free weights (e.g., dumbbells and weight plates). For example, the electronic device 101 may capture the location of the weight pin used to change weights (or the weight the weight pin is currently on) on a machine (e.g., chest fly machine, cable machine, or other machines) to determine the weight that the user is using. Free weights and powerlifting weight plates may have standard colors for each weight and standard sizes for each weight. In some examples, the electronic device 101 may add and/or subtract weights based on the weight type. For example, if the user is lifting a barbell and the electronic device 101 only “sees” one side of the barbell, the electronic device 101 may double the weight of the plates and also include the weight of the barbell to account for the plates on the other side of the barbell and the weight of the barbell. Alternatively, or additionally, in some examples, the electronic device 101 recognizes the weight of the equipment (e.g., dumbbells, weight plates, etc.) by communication with the object. For example, the electronic device 101 may scan a radio frequency identification (RFID) tag on the equipment to receive information about the equipment. The electronic device 101 may receive information about the equipment through wireless and/or wired transfer (e.g., Bluetooth, NFC tags, and/or Wi-Fi) of information between the object and the electronic device 101. Alternatively, in some examples, a user can manually input information about the equipment, such as the weight of the dumbbell, into the electronic device 101 or a different electronic device communicatively connected to the electronic device 101, such as a smart watch. FIGS. 3L-3M illustrate an example wherein the electronic device 101 does not detect the weight associated with the exercise activity.

Additionally, electronic device 101 may receive sensor data from watch 316 (e.g., a smart watch). Watch 316 is optionally recording IMU sensor data indicating movement of the user's hand and arm. In some examples, and as described below, electronic device 101 may rely on sensor data from an external device (e.g., watch 316, a smart phone, and/or a heart rate monitor) to detect an initiation of an exercise activity. For example, during an exercise where optical or motion sensors of electronic device 101 may not detect activity (e.g., during a plank or leg raises), the electronic device 101 may rely on sensor data from external devices.

In some examples, in response to detecting the initiation of an exercise activity, the electronic device 101 displays a visual indication 318 including information relating to the exercise activity. For example, and as shown in FIG. 3A, the visual indication 318 includes an indication 320a of the type of exercise activity including the weight associated with the exercise activity, an indication 320b of the number of repetitions of the exercise activity that have been completed, and an indication 320c of the number of sets of the exercise activity that have been completed. In some examples, and as described in FIG. 3G, a user can input a workout plan to determine which exercise activities and how many repetitions and sets of each exercise activity to complete using a workout settings user interface. In some examples, the visual indication 318 is floating in the three-dimensional environment (e.g., as a head-locked, body-locked, or world-locked object), such as shown in FIG. 3A. Alternatively, in some examples, the visual indication 318 is located on top of an object located in the physical environment. For example, the visual indication 318 may be located on top of a table located in the physical environment.

In some examples, if the movement associated with the identified exercise activity satisfies one or more criteria, the indication 320b is updated within visual indication 318 with the updated repetitions of the exercise activity. The one or more criteria optionally include a criterion that is satisfied if the user completes a movement associated with the exercise activity. For example, for a dumbbell curl, a repetition is defined as a movement that starts when a user holds a dumbbell with their arm straight by their side and ends when the user moves the dumbbell by curling the weight up to shoulder level. In some examples, each exercise activity has its own definition of what is considered a repetition.

Additionally, in some examples, while performing the exercise activity, the electronic device 101 displays a visual indication 322 in conjunction with visual indication 318. As shown in FIG. 3A, visual indication 322 includes a repetition counter 324 that shows the number of repetitions completed (shaded) compared to the total number of repetitions in a set. In some examples, visual indication 322 also includes an indication 326 of the number of repetitions completed, as shown in FIG. 3A. In some examples, in response to detecting a completed movement associated with the exercise activity, the electronic device 101 updates the repetition counter 324 and the indication 326 with the completed number of repetitions. In some examples, the electronic device 101 may display a visual indication similar to visual indication 322 to show process towards completing each repetition. For example, the visual indication may include a circle that fills up as the user curls the dumbbell to their shoulder. The circle may be completely filled when the user finishes a repetition of the exercise activity.

FIG. 3B shows the user finishing a dumbbell curl. As shown in FIG. 3B, the dumbbell 308 is at shoulder level, indicating a competition of the movement. In response to detecting the user finishing the movement associated with the dumbbell curl, the electronic device 101 updates the indication 320b with the current amount of completed repetitions of the exercise activity in visual indication 318. For example, when the electronic device 101 detects the user finishing a repetition of dumbbell curls, as shown in FIG. 3B, the visual indication 318 and the visual indication 322 are updated to show that 2 repetitions have been completed. In some examples, and as shown in FIG. 3B, the progress bar shown by repetition counter 324 and the indication 326 are updated to indicate that 2 repetitions have been completed.

In some examples, and as described above, the electronic device 101 recognizes the completion of a repetition of an exercise activity using sensors located on the electronic device 101 and/or from sensors on other devices communicatively connected to the electronic device 101. As shown in FIG. 3B, the electronic device 101 recognizes the completion of the repetition using an optical sensor. The user's hand 314 and the user's arm are in the field of view of the electronic device 101 and the electronic device 101 uses object recognition and/or computer vision to determine the completion of the repetition. Additionally, in FIG. 3B, the user is wearing a smart watch 316 that may transmit sensor information to electronic device 101. For example, watch 316 includes an IMU sensor that detects the movement of the arm in a motion that is consistent with a dumbbell curl. The watch 316 optionally transmits that data to the electronic device 101, which may use the data in addition to the sensor data from the sensors on the electronic device 101 to determine the completion of the repetition.

FIG. 3C illustrates an example where a user does not properly complete a repetition of an exercise activity. For example, and as shown in FIG. 3C, the user does not lift the dumbbell high enough for a dumbbell curl. As a result, the visual indication 318 and the visual indication 322 are not updated because an additional repetition was not detected as being completed successfully. In some examples, as a result of detecting an improper repetition (e.g., incomplete repetition or improper form while performing the exercise activity), the electronic device 101 provides feedback to facilitate the completion of the repetition. For example, as shown in FIG. 3C, the electronic device 101 determines that the user does not complete the additional repetition of dumbbell curls because the user did not lift the dumbbell high enough relative to the user's shoulder. As a result, the electronic device displays visual indication 327, which includes text instructing the user to lift the dumbbell 308 higher. In some examples, the electronic device 101 provides haptic feedback or transmits a request to provide haptic feedback to a communicatively connected device, such as watch 316. For example, watch 316 optionally vibrates in response to an improper repetition. In some examples, the electronic device 101 provides audio feedback to transmits a request to provide audio feedback to a communicatively connected device, such as to wireless headphones. In some examples, the audio feedback is similar to the text in the visual indication 327. In some examples, the audio feedback provides feedback instructing the user on how to complete the repetition. In some examples, one or more of the above feedback options are presented to the user when the electronic device 101 detects an improper repetition. For example, the user may receive audio, haptic, and visual feedback or any combination when the electronic device 101 detects an improper repetition.

In some examples, the user rests after a set of repetitions. In some examples, the user chooses to end a set of repetitions early. For example, the user may not be able to complete the whole set (e.g., due to time constraints, physical tiredness or fatigue, or a notification (e.g., an incoming phone call)). In some examples, the electronic device 101 detects that the user is resting by detecting that the set of repetitions is complete. For example, as shown in FIG. 3C, each set has 10 repetitions. After detecting that the 10^{th} repetition is complete, the electronic device 101 optionally stops displaying visual indication 318 and displays visual indication 328, as shown in FIG. 3D. In some examples, the electronic device 101 detects the beginning of a rest using computer vision and/or object recognition to identify a contextual change. In some examples, the electronic device 101 detects contextual changes such as not repeating the movement associated with the exercise activity and/or placing a weight down. For example, as shown in FIG. 3D, the electronic device 101 recognizes that the dumbbell 308 has been placed on the ground or floor. In some examples, the electronic device 101 recognizes an object being placed on the ground as an indication that a rest is beginning (even if the set is not complete). After detecting the object on the ground, the electronic device 101 optionally stops displaying visual indication 318 and displays visual indication 328, as shown in FIG. 3D. In some examples, the electronic device 101 uses sensor data to determine that a rest is beginning. For example, the electronic device 101 optionally uses sensor data that indicates that the user is no longer moving in a movement consistent with the exercise activity. For example, for a dumbbell curl, the electronic device 101 detects that the user is no longer moving the dumbbell in a curling motion. In some examples, if the electronic device 101 detects that the user is no longer moving in a movement consistent with the exercise activity while in the middle of a set of repetitions, the electronic device pauses the set rather than transitioning to beginning a rest. In some examples, after the completion of a last set of repetitions, the electronic device 101 may cease displaying visual indication 318 without displaying visual indication 328.

In some examples, visual indication 328 includes a timer indicating how much rest the user gets between sets and/or repetitions of the exercise activity. In some examples, and as described below, the user inputs the amount of rest in a workout settings user interface. Alternatively, in some examples, the rest timer is preprogramed and the electronic device 101 determines how much time is associated with the timer. In some examples, the timer automatically begins after the electronic device 101 detects that the rest has begun. In some examples, the user can pause the rest timer (e.g., by gazing at the visual indication 328 and/or by tapping on the visual indication 328 with a contact (e.g., a finger)) on visual indication 328 if additional rest time is needed. Alternatively or additionally, in some examples, the electronic device 101 uses sensor data to determine when the rest is over. For example, the electronic device 101 may use heart rate data to determine when the rest is complete. For example, visual indication 328 displays a resting heart rate a user needs to achieve before beginning the next set. In some examples, the electronic device 101 may use sensor data to determine how long the rest should be. For example, the electronic device 101 may set a longer rest time when detecting that the user is using heaver weights, doing more repetitions, has a higher heart rate, and/or has a higher respiration rate. For example, the electronic device 101 sets a longer rest time when the electronic device 101 detects a weight, repetition, heart rate, and/or respiration rate that is 1%, 5%, 10%, 25%, 50%, 75%, or 100% higher than previously detected for the exercise activity. Alternatively, in some examples, the electronic device 101 displays a stopwatch that records how long a user chooses to rest before resuming the exercise activity (e.g., beginning the next set). In some examples, the recorded rest time may be used to determine future rest times (e.g., with the time as described above) for the respective exercise activity.

In some examples, the electronic device 101 may display a visual indication, such as visual indication 327 shown in FIG. 3C, while the user is resting (e.g., concurrently with visual indication 328). For example, while the user is resting, the electronic device 101 may display a visual indication to coach the user for the exercise activity.

In some examples, the electronic device 101 receives an indication corresponding to the conclusion of the rest timer when the rest is complete (e.g., when the timer has run out, when the user reaches the resting heart rate, when the user resumes the exercise, and/or other requirements as described above). In some examples, after electronic device 101 detects that the rest is complete, the electronic device 101 begins counting a new set of repetitions when there are more sets of repetitions for the exercise activity. For example, in FIG. 3C, the user is on the first set of repetitions of the three sets of repetitions, therefore, after the rest is complete, the electronic device 101 begins counting repetitions in the second set of repetitions, as shown in FIG. 3E. In some examples, the electronic device 101 detects that the rest is complete by the timer ending, by detecting that a goal for the sensor data has been met, by detecting that the weights have been picked up, and/or by detecting that movements associated with the exercise activity have begun again. For example, as shown in FIG. 3E, the electronic device 101 detects that the user picked up the dumbbell 308 using the motion sensors and/or the optical sensors. In some examples, the watch 316 transmits the motion data to the electronic device 101, as similarly described above.

In some examples, the electronic device 101 may display a prompt to end the exercise activity and/or the entire workout in response to detecting that the rest period exceeds a threshold period of time. The prompt to end the exercise activity and/or the entire workout is described in further detail with respect to FIGS. 3N-3O. As shown in FIG. 3D, the electronic device 101 optionally tracks the time of rest using a rest indicator 319. In some examples, when the rest time exceeds a threshold rest time 321, the electronic device 101 displays a prompt to end the exercise activity and/or the entire workout. In some examples, without detecting the resumption of the exercise activity (e.g., a new set of the exercise activity) or a new exercise activity, the rest period is allowed to run until the threshold rest time 321 (and exceed the threshold rest time). In some examples, the threshold rest time 321 may be the amount of time set on the timer (e.g., determined using the workout settings user interface, as described above) optionally plus a buffer amount of time. For example, if the user gets 30 seconds of rest between sets of dumbbell curls, as shown in FIG. 3D, then the threshold rest time may be 1 minute. In some examples, the buffer amount of time may be 30 seconds, 1 minute, 5 minutes, or 10 minutes. In some examples, the threshold rest time 321 may be a preset amount of time (e.g., 30 seconds, 1 minute, 2 minutes, or 5 minutes).

In some examples, after detecting the start of a new set of repetitions, the electronic device 101 stops displaying visual indication 328 and begins displaying visual indication 318 and visual indication 322. In response to detecting the start of a new set of repetitions, the repetition counter shown by indication 320b, repetition counter 324, and the indication 326 are reset to begin counting repetitions for the new set.

In some examples, if the electronic device 101 detects a change in weight (e.g., adding weight, lowering weight, or switching to body weight), during a set of repetitions or at the start of a set of repetitions, the electronic device 101 updates indication 320a with the new weight. For example, if the user changes the dumbbell 308 in FIG. 3E with a different dumbbell of a different weight, then, the electronic device 101 automatically updates indication 320a with the new weight of the new dumbbell. Alternatively, in some examples, the user prompts the electronic device 101 to update the indication 320a with a different weight. In some examples, in response to detecting a change in the weight, the electronic device 101 resets the repetition counter. Alternatively, in some examples, in response to detecting a change in weight, the electronic device 101 continues the repetition counter.

FIG. 3F illustrates an example of user interfaces displayed when the electronic device 101 detects that the user is resting after completing an exercise activity (e.g., completed all sets) and will move to a different exercise activity afterwards. As described in FIG. 3D, after detecting the end of the set of repetitions, the electronic device begins displaying the visual indication 328 showing the rest timer. In some examples, the electronic device 101 detects the end of the last set of repetitions of the exercise activity. For example, the user is on the third of three sets of dumbbell curls and the electronic device 101 detects the last repetition of the set of dumbbell curls. In some examples, the electronic device 101 knows that the user is on the last set of an exercise activity based on a workout plan, optionally a user-selected or user-configured workout plan. The workout plan determines which exercise activities and how many repetitions and sets of each exercise activity (or distance/time for a cardio activity) are to be performed, as described with respect to FIG. 3I. As a result of the electronic device 101 detecting the end of the last set of repetitions (and/or that the user places the dumbbell 318 on the ground), the electronic device 101 displays visual indication 329, as shown in FIG. 3F. Visual indication 329 includes one or more characteristics of visual indication 328 as described in FIG. 3D. In some examples, visual indication 329 also includes text and/or figures describing the next exercise activity in the workout plan or a suggested exercise for a freeform workout. For example, in FIG. 3F, visual indication 329 indicates that the next exercise activity is “exercise biking.” In some examples, the electronic device 101 displays visual indication 329 including the description of the next exercise activity when the user is following a predetermined workout plan.

In some examples, the electronic device 101 detects a change in the exercise activity during a workout. In some examples, the electronic device 101 detects a change in the exercise activity by using object recognition and motion sensors to detect a change in physical environment, a change in equipment, a change in weight, and/or a change in motion. For example, as shown in FIG. 3G, the point of view of the user of the electronic device 101 (e.g., facing an exercise bike 332 in a gym in which electronic device 101 is located) has changed. In some examples, the electronic device 101 detects a change in exercise activity while the user has not finished completing the sets of a different exercise activity (e.g., the user has not completed all sets of dumbbell curls). For example, the user is performing the repetitions of the second set of dumbbell curls in FIG. 3E. In some examples, the electronic device 101 detects a change in exercise activity after the user has finished the sets of the previous exercise activity (e.g., the user starts biking on bike 332 after completing the sets of dumbbell curls). In some examples, the electronic device 101 detects the type of exercise activity by detecting a pose of the electronic device 101. In some examples, the pose of the electronic device is an orientation of the electronic device 101 with respects to the world (e.g., relative to a gravity vector). For example, and as described above, the field of view of the electronic device 101 changes. For example, the electronic device 101 detects that the user is on the exercise bike by detecting that the electronic device 101 is pointed towards a handle bar. In response to detecting the user change exercise activities from dumbbell curls to the exercise bike, as shown in FIG. 3G, the electronic device 101 stops displaying visual indication 318 and visual indication 322, and displays a visual indication 330 relevant to the second exercise activity (e.g., biking). In some examples, the electronic device continues to display visual indication 318 and visual indication 322 with updated information if the visual indications are relevant to the second exercise activity. For example, if the user continued to do strength-based activities that involve counting repetitions and sets of repetitions, then the electronic device continues to display visual indication 318 and visual indication 322. In such cases, indication 320a is updated with the present exercise activity and weight amounts and the repetition counters shown by indication 320b, repetition counter 324, and the indication 326 are reset to begin counting repetitions for the second workout activity. In some examples, in response to detecting the change in exercise activity, the electronic device 101 automatically ceases presentation of the representation of the repetitions of the first exercise activity and begins presenting the representation of repetitions of the second exercise activity.

As shown in FIG. 3G, the electronic device 101 stops displaying visual indication 318 and visual indication 322 and displays a visual indication 330 in response to the change in exercise activity. Because biking workouts are more commonly represented with heart rate zones, biking time(s), and/or biking distance(s), the representation of the repetitions shown with visual indication 318 and visual indication 326 are changed to visual indication 330 to represent heart rate zones and current time biked. In some examples, other cardio based exercise activities, such as running or rowing, may also include visual indication 330 rather than visual indications 318 and 326. As shown in FIG. 3G, visual indication 330 includes text describing the exercise activity (“exercise bike”), the heart rate zone (“Zone 5”), the time remaining (“2:00”), and the heart rate (“140”). In some examples, the electronic device 101 receives heart rate information from watch 316.

In some examples, the user can input a workout plan to determine which exercise activities and how many repetitions and sets of each exercise activity (or distance/time for a cardio activity) are to be performed. For example, as shown in FIG. 3H, the user may customize the number of sets and repetitions per set, a time, distance, or heart rate goal for a given exercise activity in a workout settings user interface 336. The user may also customize rest time between each set for each exercise activity and/or between each exercise activity. In some examples, a user can access the workout settings user interface 336 through an input on a visual indication (e.g., 330, 324, or 318). For example, in response to an input (e.g., a gaze, a pinch, or a tap input) using contact 334 (e.g., a finger or fingers of the user's hand) directed to visual indication 330, shown in FIG. 3G, the electronic device 101 displays the workout setting user interface 336. In some examples, the workout settings user interface 336 is displayed on electronic device 101. In some examples, the workout settings user interface 336 is remotely displayed on a different device (e.g., such as on a watch (e.g., watch 316), a phone, and/or a tablet) communicatively connected to electronic device 101.

In some examples, the electronic device 101 stores the workout plan discussed above. In some examples, the electronic device 101 stores the performed workout (e.g., the workout including the sets and the repetitions of exercise activities that were actually performed, rest duration, workout duration, heartrate, calories burned, distance, etc.). In some examples, the electronic device 101 may reference the previously performed workout during new workouts. For example, the electronic device 101 may change the required sets and/or repetitions if, during the previous workout, the user did not finish the required (e.g., programmed and/or preset) sets and/or repetitions. In some examples, the user can access the previously performed workouts to track their progress. In some examples, the electronic device 101 may use the data from the previously performed workouts to analyze the user's strength (e.g., lifting and/or cardio strength), stamina, and/or overall fitness level. In some examples, the electronic device 101 may include premade workout plans that the user may select in the workout settings user interface 336.

FIGS. 3I-3K illustrate an example of an exercise activity (e.g., lunges) using only bodyweight. Since lunges are a strength exercise, electronic device 101 presents visual indications 318 and 322, as shown in FIG. 3I-3K. In FIG. 3I, a user is starting the 6^{th} lunge in the set of repetitions. In some examples, the electronic device 101 detects the type of exercise activity (e.g., lunges) using a skeletal pose of the user. For example, the electronic device 101 detects the initiation of the lunge (and that the exercise activity is a lunge) using optical sensors to recognize that the user's foot 342 is in front of a torso of the user and that the user's knee is straight. Additionally or alternatively, in some examples, the electronic device 101 detects the type of activity using a pose of the electronic device 101, as described above. For example, during a lunge, the electronic device 101 has a field of view of the floor and the user's lower extremities. During the lunge, the electronic device 101 detects that the user's knee 340 is bending, as shown in FIG. 3J. At the end of the repetition of the lunge, the electronic device 101 detects that the user's knee 340 is bent at a 90° angle (or within a threshold amount of being 90 degrees, such as 80, 82, 85, 88, etc. degrees) over the user's foot 342, as shown in FIG. 3K. In response to detecting the end of the repetition, the electronic device 101 updates visual indication 318 (including visual indication 320b) and the visual indication 322 (including repetition counter 324 and indication 326) to show that the 6^{th} repetition is complete. In some examples, the electronic device 101 may use other sensor data such as motion data from sensors on the electronic device 101 or from other devices, such as watch 316, to determine the movements of the exercise activity, as described above.

FIG. 3L illustrates an example indication of when the electronic device 101 does not detect the amount of weight. In some examples, the electronic device 101 cannot identify the weight associated with an exercise activity (e.g., the weight associated with the dumbbell is not within the field of view of the cameras of electronic device 101), and as a result, the electronic device 101 optionally displays a visual indication 350, as shown in FIG. 3L. In some examples, the visual indication 350 includes text and/or images prompting the user to show the weight associated with the exercise activity into the field of view of the electronic device 101. In some examples, the content of visual indication 350 may be integrated in visual indication 318. Alternatively, or additionally, the electronic device 101 may use other forms of notification such as haptic or audio indications to indicate to the user to show the weight associated with the exercise activity. When the electronic device 101 does not detect the weight, the electronic device 101 displays visual indication 318 without the weight of the exercise activity. In some examples, the electronic device 101 may display a question mark, dash, text, or other suitable indicator in place of the numerical weight of the exercise activity to indicate that the electronic device 101 cannot identify the weight. Additionally, the electronic device 101 does not record the weight associated with the exercise activity. As shown in FIG. 3L, the electronic device 101 identifies the exercise activity, the repetitions, and the sets with visual indication 318. However, the electronic device 101 does not indicate the weight used.

In response to displaying visual indication 350, the user turns the dumbbell such that the amount of weight is facing the camera, as shown in FIG. 3M. As a result, the electronic device 101 updates visual indication 318 with the weight and ceases displaying visual indication 350. In some examples, the user may indicate the weight by manually inputting the weight into the electronic device 101, by placing the weight amount in the view of the cameras of electronic device 101, and in other ways as described in FIG. 3A. In some examples, the electronic device 101 ceases to display the visual indication 350 after the electronic device 101 identifies the weight (e.g., by manual input or by “seeing” the weight with the sensors) or after a timeout period (e.g., 3 seconds, 10 seconds, etc.) after displaying visual indication 350.

FIGS. 3N-3P illustrate an example of an electronic device tracking a freeform workout. In some examples, and as described above, a user may begin working out without a predefined workout plan. In some such examples, the electronic device 101 may not have a predefined number of repetitions of an exercise activity, a predefined number of sets of an exercise activity, and/or a predefined amount of rest time for a between sets or exercise activities. Because these details are not predefined, the electronic device 101 includes a disambiguation period before displaying visual indication 318 that includes information about the exercise activity when detecting the exercise activity and/or before displaying visual indication 328 about rest time when detecting rest. In some examples, the disambiguation period is used to allow the electronic device 101 to gain confidence in the type of exercise activity and/or whether the user is resting. While in the disambiguation period, the electronic device 101 is optionally still counting repetitions and/or tracking rest that occurs before the disambiguation period is complete, but the electronic device is not displaying the associated visual indication until the disambiguation period is over.

FIG. 3N illustrates an example wherein the user is engaged in dumbbell curls with 10 lb weights. The electronic device 101 displays visual indication 318 including text describing the exercise activity, the weight, and the number of repetitions completed. Because of the disambiguation period necessary to gain confidence in the activity, the repetition count does not begin at zero repetitions. For example, FIG. 3N illustrates the repetition count begins at 3 repetitions. In some examples, the beginning repetition count may vary depending on the time it takes for the electronic device 101 to gain a threshold confidence to determine the exercise activity and display the indication. As the user completes more repetitions, the repetition counter in visual indication 318 increments with each post-display completion. In some examples, the user may manually change the exercise activity and/or repetitions completed to account for errors and/or changes that are not automatically detected and/or accounted for.

In some examples, the user stops performing the exercise activity and begins a rest. For example, the user stops completing dumbbell curls and sets the dumbbells on the ground or a dumbbell rack. After the disambiguation period to determine with confidence that the user is resting, the electronic device 101 displays visual indication 328, as shown in FIG. 3O. The electronic device 101 may determine that the user is resting, such as using the one or more techniques as described with respect to FIG. 3D. In some examples, while the user is performing freeform exercise, the electronic device 101 displays a timer indicating the elapsed duration of the rest (e.g., a stopwatch counting up time). Because the electronic device 101 displays indication 328 after the disambiguation period (e.g., after determining rest with greater than a threshold confidence), the timer does not start at 0:00 and instead, starts with a non-zero start time to account for the elapsed time between the conclusion of the disambiguation period and when the electronic device 101 determines that the rest has begun (at lower than the threshold confidence).

In some examples, the electronic device 101 may detect rest without first detecting the exercise activity. For example, the electronic device 101 does not display visual indication 318 while the user is performing an undetected exercise activity (or detected with less than a threshold confidence). Additionally, in such an example, the electronic device 101 does not record or does not display any data relating to the exercise activity. However, the electronic device 101 determines that the user ceases performing exercise activities and displays visual indication 328 during resting periods so that the user knows how long they have been resting.

In some examples and as shown in FIG. 3P, after the rest time has exceeded a rest threshold 321 (different than and greater than duration of the rest period), as indicated by rest indicator 319, the electronic device 101 displays a visual indication 352 prompting the user to end the workout and/or exercise activity. As described in FIG. 3D, the rest threshold 321 may be a pre-determined amount of time. For example, the rest threshold is set at 3 minutes. As shown in FIG. 3P, the visual indication 352 includes a selectable option to end the activity and a selectable option to close the prompt. In some examples, the user may be taking an extended rest before resuming exercising. However, in some examples, the extended rest (e.g., rest exceeding the threshold rest time) is indicative of the user finishing their workout and/or exercise activity. In some examples, the electronic device 101 may auto-end the workout and/or auto-dismiss the visual indication 352. For example, the electronic device 101 may automatically end the workout and/or dismiss the visual indication 352 after an amount of time past the threshold rest time (e.g., a predetermined amount of time after the threshold rest time has been exceeded such as 2 minutes after the threshold rest time).

In some examples, the electronic device 101 may display a visual indication (or audio message) including a workout summary after the workout has ended (e.g., by exceeding rest time, by finishing the workout plan, or by manually ending the workout). In some examples, the workout summary includes text (and/or audio) describing the exercise activities performed, the amount of rest taken (total and/or per set of repetitions), the amount of weight used, and/or coaching associated with the exercise activities.

FIG. 3Q illustrates an example of the electronic device 101 detecting a group exercise class. In some examples, the electronic device 101 detects a group workout based on contextual information from the environment (e.g., using the one or more sensors on the electronic device 101 such as an outward facing camera). For example, a group workout may be indicated by detecting a mirror 354 indicative of a setting for a group workout class. Additionally or alternatively, a group workout may be indicated by detecting other participants in the field of view and/or in the mirror performing the same or similar movements and/or exercises (e.g., same or similar movements, poses, cadence, etc.). In some examples, the electronic device 101 can detect that the other people shown in the mirror are performing the exercises appear mirrored (inverted) from the user of the electronic device 101. Additionally or alternatively, a group workout may be indicated by detecting an arrangement of other participants (e.g., arrangement of participants spread horizontally or vertically in the environment. In some examples, after detecting that the user is in a group workout, the electronic device 101 displays visual indication 356, as shown in FIG. 3Q, of the group workout (rather than an individual workout). In some examples, visual indication 356 includes a textual and/or visual description that the user is in a group workout class. The visual indication 356 may also include a timer that counts how long the user has been in the group workout class. In some examples, the electronic device 101 may also display each exercise the user is performing while in the group workout class by determining the exercise activity using one or more methods as described herein.

FIG. 3R illustrates an example of the electronic device 101 detecting an initiation of an exercise activity and/or the type of exercise activity using one or more input devices, including the image sensors 206, orientation sensors 210, and/or microphones 213. As described above, the electronic device 101 uses the one or more sensors to identify movement. In some examples, the electronic device 101 uses an IMU sensor of the electronic device 101 or of a different device in communication with the electronic device 101 (e.g., a smart watch or phone) to detect movement that is consistent with exercise. For example, movement that includes traveling distances for a prolonged period of time (e.g., walking, running, biking), bouncing, rapid acceleration and deceleration, and other movements consistent with one or more sports/exercises. In some examples, the electronic device 101 also uses heart rate sensors (e.g., heart rate sensors of a second electronic device such as a watch or ring) to detect elevated heart rates which may correspond to an initiation of an exercise activity. Additionally, in some examples, the electronic device 101 uses the microphones 213 to detect sounds that are matched to a respective exercise activity. For example, in FIG. 3R, the electronic device 101 uses microphones 213 and/or other audio sensors on the electronic device 101 or on a second electronic device in communication with electronic device 101 to detect one or more sounds (e.g., squeaking of basketball shoes, sounds of the basketball bouncing) to determine that the exercise activity is basketball. Additionally, or alternatively, the electronic device 101 uses the one or more image sensors 206 to capture one or more media items (e.g., images and/or videos) of the user's surroundings (e.g., physical environment 304) to be used to determine the exercise activity. As described above, the electronic device 101 uses object recognition to determine the exercise activity. For example, in FIG. 3F, the electronic device 101 captures one or more images including a basketball, basketball hoop, and/or people wearing basketball jerseys to determine that the user is playing basketball. In some examples, the electronic device 101 continues capturing media items and/or sounds until the media items and/or sounds satisfy one or more criteria. For example, the one or more criteria are satisfied when the electronic device 101 is able to use object detection and/or OCR on the one or more images and/or the one or more sounds to determine the type of exercise activity (e.g., the images are not blurry, the images capture on or more objects that correlate to a respective exercise activity, and/or the sounds correlate to a sound of a respective exercise activity). Using a plurality of sensors including the microphone and the image sensors to supplement the IMU sensor allows the electronic device to accurately determine the type of exercise activity that the user is performing, thereby reducing erroneous inputs to the electronic device and improving battery life.

In some examples, the electronic device 101 does not activate detecting using one or more image sensors 206 or microphone 213 until the electronic device 101 detects one or more movements using the IMU sensor that is consistent with an initiation of an exercise activity. Alternatively, in some examples, the electronic device 101 does not activate detecting use the one or more image sensors 206 until the electronic device 101 detects one or more sounds that satisfy the one or more criteria using the microphone 213 (or other audio sensors of the electronic device 101 or a second electronic device). In some examples, the electronic device 101 detects using additional sensors (e.g., image sensors and/or audio sensors) when a threshold confidence level has not been met by the first set of sensors (e.g., the IMU sensor only, the image sensor only, the audio sensors only, or a combination of the aforementioned sensors). For example, if the electronic device 101 has a confidence level higher than the threshold confident level of the initiation of the exercise activity and the type of exercise activity using the IMU sensor, the electronic device 101 does not activate detection using the image or audio sensors.

Only activating additional sensors after the electronic device 101 detects that the user has initiated an exercise activity reduces the number of sensors active at a given time, thereby improving battery life of the electronic device 101.

In FIG. 3R, the electronic device 101 presents visual indication 358, which has one or more characteristics of visual indication 356 shown in FIG. 3Q. After detecting the initiation of the exercise activity and the type of exercise activity (e.g., basketball), the electronic device 101 displays visual indication 358 including a timer indicating the current duration of the exercise activity and the name of the exercise activity.

Although the features herein are primarily described with visual features (e.g., visual indications and user interfaces), it should be noted that some of the features can be achieved without necessarily displaying user interfaces or visual indication. Moreover, in some examples, the electronic device 101 described herein does not necessarily include a display. For example, the electronic device 101 may track exercise activities (e.g., repetitions and sets of repetitions), track weights associated with exercise activities, provide coaching, and/or track rest using sensors and/or other output mechanisms (e.g., audio, haptic) without displaying visual indications and/or user interfaces. In some examples, the electronic device 101 may provide audio and/or haptic indications in addition to or in place of visual indications.

FIG. 4 illustrates an example process of how an electronic device records and tracks exercise activities. Automatically recording and tracking exercise activities allows the user to receive real-time feedback, and automatic initiation, tracking, and recording of workouts (e.g., of mixed exercise activity workouts), therefore allows the user to workout efficiently and effectively. In some examples, process 400 begins at an electronic device in communication with a display and one or more input devices. In some examples, the electronic device is optionally a head-mounted display similar or corresponding to device 201 of FIG. 2. As shown in FIG. 4, in some examples, the electronic device detects (402a), using the one or more input devices including an optical sensor, an initiation of an exercise activity associated with a user of the electronic device. For example, the electronic device (e.g., electronic device 101 in FIG. 3A) detects the initiation of the dumbbell curl by detecting the user holding the dumbbell 308 in FIG. 3A using object recognition and a motion of the hand 314 in FIG. 3A in a motion consistent with a dumbbell curl.

In some examples, the electronic device presents (402b), using the one or more displays (e.g., display 120 in FIG. 1), a view of the physical environment of the electronic device, such as using three-dimension environment 300 shown in FIG. 3A, and a user interface that includes a representation of the exercise activity (or representations of repetitions for exercise activities with repetitions), such as visual indication 318 and visual indication 322 in FIG. 3A, and/or visual representation 330 in FIG. 3G.

In some examples, while presenting the user interface that includes the representation of the exercise activity, the electronic device detects (402c), using the one or more input devices, an input. For example, the electronic device detects movement of the user (e.g., the user performing the exercise activity), such that the movement of the user to perform a lunge in FIGS. 3I-3K.

In some examples, in response to detecting the input (402d), in accordance with a determination that the input satisfies one or more first criteria (402e), the electronic device updates (402f) a presentation of the exercise activity in the user interface. For example, in response to the completion of a dumbbell curl in FIG. 3B, the electronic device 101 updates the visual indication 318 and the visual indication 322 to indicate that a repetition has been completed.

In some examples, in response to detecting the input (402d), in accordance with a determination that the input does not satisfy one or more first criteria (402g), the electronic device forgoes updating (402h) the presentation of the exercise activity in the user interface. For example, in response to an incomplete repetition of a dumbbell curl in FIG. 3C, the electronic device 101 does not update the visual indication 318 and the visual indication 322 to indicate that a repetition has been completed.

It is understood that process 400 is an example and that more, fewer, or different operations can be performed in the same or in a different order. Additionally, the operations in process 400 described above are, optionally, implemented by running one or more functional modules in an information processing apparatus such as general-purpose processors (e.g., as described with respect to FIG. 2) or application specific chips, and/or by other components of FIG. 2. Therefore, according to the above, some examples of the disclosure are directed to a method, comprising at an electronic device in communication with one or more displays, and one or more input devices: detecting, using the one or more input devices including an optical sensor, an initiation of an exercise activity associated with a user of the electronic device; presenting, using the one or more displays, a view of a physical environment of the electronic device and a user interface that includes a representation of the exercise activity; while presenting the user interface that includes the representation of the exercise activity, detecting, using the one or more input devices, an input; and in response to detecting the input: in accordance with a determination that the input satisfies one or more first criteria, updating a presentation of the representation of the exercise activity in the user interface; and in accordance with a determination that the input does not satisfy the one or more first criteria, forgoing updating the presentation of the representation of the exercise activity in the user interface. Additionally or alternatively to one of more of the examples disclosed above, in some examples the representation of the exercise activity includes a representation of repetitions of the exercise activity. Additionally or alternatively to one of more of the examples disclosed above, in some examples, the one or more first criteria corresponds to a completion of a repetition of the exercise activity. Additionally or alternatively to one of more of the examples disclosed above, in some examples, the method further comprises detecting, using the one or more input devices including the optical sensor, a weight associated with the exercise activity. Additionally or alternatively to one of more of the examples disclosed above, in some examples, the method further comprises in accordance with a determination that the input satisfies one or more second criteria including a criterion that is satisfied when a set of repetitions of the exercise activity is complete, presenting a rest user interface; and in accordance with a determination that the input does not satisfy the one or more second criteria, forgoing presenting the rest user interface. Additionally or alternatively to one of more of the examples disclosed above, in some examples, the one or more second criteria include a criterion that is satisfied when a contextual change of a physical environment is detected. Additionally or alternatively to one of more of the examples disclosed above, in some examples, the method further comprises in accordance with the determination that the input satisfies the one or more second criteria, ceasing the presentation of the user interface that includes the representation of repetitions of the exercise activity. Additionally or alternatively to one of more of the examples disclosed above, in some examples, the method further comprises while presenting the rest user interface, receiving an indication corresponding to conclusion of a rest; and response to receiving the indication: ceasing the presentation of the rest user interface; and in accordance with a determination that the indication satisfies one or more third criteria including a criterion that is satisfied when less than a threshold number of sets of repetitions of the exercise activity is complete, presenting the user interface including an updated representation of repetitions of the exercise activity. Additionally or alternatively to one of more of the examples disclosed above, in some examples, the method further comprises in accordance with the determination that the input satisfies the one or more second criteria, presenting an indication of a next activity within the rest user interface or displaying a next activity user interface concurrently with the rest user interface. Additionally or alternatively to one of more of the examples disclosed above, in some examples, the method further comprises while presenting the rest user interface, detecting a period of rest greater than a threshold period; and in response to detecting the period of rest greater than the threshold period, presenting an end user interface and/or ceasing displaying the rest user interface. Additionally or alternatively to one of more of the examples disclosed above, in some examples, the method further comprises detecting, using the one or more input devices, a second input; and in response to detecting the input: in accordance with a determination that the second input satisfies one or more fourth criteria including a criterion that is satisfied when a second exercise activity different than the exercise activity is detected, presenting a user interface including a representation of the second exercise activity. Additionally or alternatively to one of more of the examples disclosed above, in some examples, detecting the input further comprises detecting the input using skeletal tracking. Additionally or alternatively to one of more of the examples disclosed above, in some examples, detecting the input further comprises detecting the input using object recognition. Additionally or alternatively to one of more of the examples disclosed above, in some examples, the method further comprises in accordance with the determination that the input does not satisfy the one or more first criteria, providing feedback to facilitate completion of a repetition of the exercise activity. Additionally or alternatively to one of more of the examples disclosed above, in some examples, the method further comprises while presenting the view of the physical environment of the electronic device and the user interface that includes the representation of the exercise activity, presenting a representation of a weight associated with the exercise activity, a representation of an exercise activity, and a representation of a number of sets of repetitions of the exercise activity. Additionally or alternatively to one of more of the examples disclosed above, in some examples, detecting the initiation of the exercise activity further comprises obtaining motion data from a second electronic device communicatively coupled to the electronic device. Additionally or alternatively to one of more of the examples disclosed above, in some examples, the method further comprises storing a representation of the exercise activity and the representation of the repetitions of the exercise activity on the electronic device. Additionally or alternatively to one of more of the examples disclosed above, in some examples, detecting the initiation of the exercise activity comprises detecting a type of exercise activity. Additionally or alternatively to one of more of the examples disclosed above, in some examples, detecting the type of exercise activity further comprises detecting a physical object using the one or more input devices including the optical sensor. Additionally or alternatively to one of more of the examples disclosed above, in some examples, detecting the type of exercise activity further comprises detecting a pose of the electronic device. Additionally or alternatively to one of more of the examples disclosed above, in some examples, detecting the type of exercise activity further comprises detecting a skeletal pose of the user. Additionally or alternatively to one of more of the examples disclosed above, in some examples, the method further comprises in accordance with a determination that the input includes an interaction with exercise equipment having an associated weight characteristic without detecting the weight, prompting for a second input indicating the weight of the exercise equipment. Additionally or alternatively to one of more of the examples disclosed above, in some examples, the method further comprises in accordance with a determination that the input satisfies one or more second criteria including a criterion that is satisfied when an exercise activity is no longer detected; presenting a rest user interface that accounts for a disambiguation period, wherein the rest user interface is presented after the disambiguation period.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

1. A method comprising:
at an electronic device in communication with one or more displays, and one or more input devices:
detecting, using the one or more input devices including an optical sensor, an initiation of an exercise activity associated with a user of the electronic device;
presenting, using the one or more displays, a view of a physical environment of the electronic device and a user interface that includes a representation of the exercise activity;
while presenting the user interface that includes the representation of the exercise activity, detecting, using the one or more input devices, an input; and
in response to detecting the input:
in accordance with a determination that the input satisfies one or more first criteria, updating a presentation of the representation of the exercise activity in the user interface; and
in accordance with a determination that the input does not satisfy the one or more first criteria, forgoing updating the presentation of the representation of the exercise activity in the user interface.

2. The method of claim 1, wherein the representation of the exercise activity includes a representation of repetitions of the exercise activity.

3. The method of claim 1, wherein the one or more first criteria correspond to a completion of a repetition of the exercise activity.

4. The method of claim 1, further comprising:
detecting, using the one or more input devices including the optical sensor, a weight associated with the exercise activity.

5. The method of claim 1, further comprising:
in accordance with a determination that the input satisfies one or more second criteria including a criterion that is satisfied when a set of repetitions of the exercise activity is complete, presenting a rest user interface; and
in accordance with a determination that the input does not satisfy the one or more second criteria, forgoing presenting the rest user interface.

6. The method of claim 1, further comprising:
detecting, using the one or more input devices, a second input; and
in response to detecting the input:
in accordance with a determination that the second input satisfies one or more fourth criteria including a criterion that is satisfied when a second exercise activity different than the exercise activity is detected, presenting a user interface including a representation of the second exercise activity.

7. The method of claim 1, wherein detecting the initiation of the exercise activity further includes detecting a movement consistent with exercise using one or more motion or orientation sensors, the method further comprising:
after detecting the initiation of the exercise activity, detecting, using the one or more input devices including the optical sensor and a microphone, a type of exercise activity.

8. The method of claim 1, further comprising:
in accordance with a determination that the input satisfies one or more second criteria, including a criterion that is satisfied when an exercise activity is no longer detected, presenting a rest user interface that accounts for a disambiguation period, wherein the rest user interface is presented after the disambiguation period.

9. An electronic device comprising:
a display;
a memory;
one or more displays;
one or more input devices;
one or more processors; and
one or more programs stored in the memory and configured to be executed by the one or more processors, the one or more programs including instructions for:
detecting, using the one or more input devices including an optical sensor, an initiation of an exercise activity associated with a user of the electronic device;
presenting, using the one or more displays, a view of a physical environment of the electronic device and a user interface that includes a representation of the exercise activity;
while presenting the user interface that includes the representation of the exercise activity, detecting, using the one or more input devices, an input; and
in response to detecting the input:
in accordance with a determination that the input satisfies one or more first criteria, updating a presentation of the representation of the exercise activity in the user interface; and
in accordance with a determination that the input does not satisfy the one or more first criteria, forgo updating the presentation of the representation of the exercise activity in the user interface.

10. The electronic device of claim 9, wherein the representation of the exercise activity includes a representation of repetitions of the exercise activity.

11. The electronic device of claim 9, wherein the one or more first criteria correspond to a completion of a repetition of the exercise activity.

12. The electronic device of claim 9, wherein the one or more programs including instructions for:
detecting, using the one or more input devices including the optical sensor, a weight associated with the exercise activity.

13. The electronic device of claim 9, wherein the one or more programs including instructions for:
in accordance with a determination that the input satisfies one or more second criteria including a criterion that is satisfied when a set of repetitions of the exercise activity is complete, presenting a rest user interface; and
in accordance with a determination that the input does not satisfy the one or more second criteria, forgoing presenting the rest user interface.

14. The electronic device of claim 9, wherein the one or more programs including instructions for:
detecting, using the one or more input devices, a second input; and
in response to detecting the input:
in accordance with a determination that the second input satisfies one or more fourth criteria including a criterion that is satisfied when a second exercise activity different than the exercise activity is detected, presenting a user interface including a representation of the second exercise activity.

15. The electronic device of claim 9, wherein detecting the initiation of the exercise activity further includes detecting a movement consistent with exercise using one or more motion or orientation sensors; and
after detecting the initiation of the exercise activity, detecting, using the one or more input devices including the optical sensor and a microphone, a type of exercise activity.

16. The electronic device of claim 9, further comprising:
in accordance with a determination that the input satisfies one or more second criteria including a criterion that is satisfied when an exercise activity is no longer detected;
presenting a rest user interface that accounts for a disambiguation period, wherein the rest user interface is presented after the disambiguation period.

17. A non-transitory computer readable storage medium storing one or more programs, the one or more programs comprising instructions, which when executed by one or more processors of an electronic device, cause the electronic device to perform a method comprising:
detecting, using one or more input devices including an optical sensor, an initiation of an exercise activity associated with a user of the electronic device;
presenting, using one or more displays, a view of a physical environment of the electronic device and a user interface that includes a representation of the exercise activity;
while presenting the user interface that includes the representation of the exercise activity, detecting, using the one or more input devices, an input; and
in response to detecting the input:
in accordance with a determination that the input satisfies one or more first criteria, updating a presentation of the representation of the exercise activity in the user interface; and
in accordance with a determination that the input does not satisfy the one or more first criteria, forgo updating the presentation of the representation of the exercise activity in the user interface.

18. The non-transitory computer readable storage medium of claim 17, wherein the representation of the exercise activity includes a representation of repetitions of the exercise activity.

19. The non-transitory computer readable storage medium of claim 17, wherein the one or more first criteria correspond to a completion of a repetition of the exercise activity.

20. The non-transitory computer readable storage medium of claim 17, further comprising:
detecting, using the one or more input devices including the optical sensor, a weight associated with the exercise activity.

21. The non-transitory computer readable storage medium of claim 17, further comprising:
in accordance with a determination that the input satisfies one or more second criteria including a criterion that is satisfied when a set of repetitions of the exercise activity is complete, presenting a rest user interface; and
in accordance with a determination that the input does not satisfy the one or more second criteria, forgoing presenting the rest user interface.

22. The non-transitory computer readable storage medium of claim 17, further comprising:
detecting, using the one or more input devices, a second input; and
in response to detecting the input:
in accordance with a determination that the second input satisfies one or more fourth criteria including a criterion that is satisfied when a second exercise activity different than the exercise activity is detected, presenting a user interface including a representation of the second exercise activity.

23. The non-transitory computer readable storage medium of claim 17, wherein detecting the initiation of the exercise activity further includes detecting a movement consistent with exercise using one or more motion or orientation sensors; the method further comprising:
after detecting the initiation of the exercise activity, detecting, using the one or more input devices including the optical sensor and a microphone, a type of exercise activity.

24. The non-transitory computer readable storage medium of claim 17, further comprising:
in accordance with a determination that the input satisfies one or more second criteria including a criterion that is satisfied when an exercise activity is no longer detected;
presenting a rest user interface that accounts for a disambiguation period, wherein the rest user interface is presented after the disambiguation period.
